(19) United States
(12) Patent Application Publication
(10) Pub. No.: US 2015/0296250 A1
(43) Pub. Date: Oct. 15, 2015

(54) METHODS, SYSTEMS, AND MEDIA FOR PRESENTING COMMERCE INFORMATION RELATING TO VIDEO CONTENT

(71) Applicant: Google Inc., Mountain View, CA (US)

(72) Inventor: Kariyushi Casper, Chicago, IL (US)

(21) Appl. No.: 14/249,840

(22) Filed: Apr. 10, 2014

(51) Int. Cl. H04N 21/431; H04N 21/254; H04N 21/458; G06Q 30/06; H04N 21/478; H04N 21/41; G06Q 30/02; H04N 21/234; H04N 21/81

(52) U.S. Cl. CPC H04N 21/4316; H04N 21/23418; H04N 21/2542; H04N 21/458; H04N 21/812; H04N 21/47815; H04N 21/4126; G06Q 30/0267; G06Q 30/0641

(57) ABSTRACT

Methods, systems, and media for presenting commerce information relating to video content are provided. In some implementations, the method comprises: receiving a plurality of video frames including a first video frame; detecting a plurality of objects in the plurality of video frames; identifying a plurality of merchandise items corresponding to the detected plurality of objects; obtaining commerce information corresponding to the each of the plurality of merchandise items; associating the commerce information corresponding to each of the plurality of merchandise items with at least one of the plurality of video frames; receiving, from a mobile device, an indication that video content being played back on the mobile device has been paused, wherein the indication includes an identification of the first video frame; and transmitting a response to the mobile device that includes the commerce information associated with the first video frame.

### TECHNICAL FIELD

Methods, systems, and media for presenting commerce information relating to video content are provided.

### BACKGROUND

While watching a program, a viewer is often interested in information relating to the program, such as additional information about merchandise items (e.g., clothing, homegoods, health products, etc.) presented in the program. To find information about a merchandise item presented in the program using a conventional search engine, the viewer may have to enter one or more keywords into the search engine. The viewer can then scan through search results to find a webpage containing information relating to the merchandise item.

However, such a conventional search engine may not provide a user with a satisfactory search experience for several reasons. For example, the viewer may have to compose a search query for a merchandise item relying solely on the appearance of the merchandise item as shown in a video frame. This can be a time consuming and frustrating procedure for the viewer, especially when the viewer is unaware of the search terms (e.g., a product name) that may lead to the merchandise item that the user is looking for. As another example, a viewer may have to conduct multiple searches to review information relating to multiple merchandise items displayed in a program. As a result, the viewer may have to miss a substantial portion of the program while searching for information relating to merchandise items.

Accordingly, it is desirable to provide new mechanisms for presenting commerce information relating to video content.

### SUMMARY

Methods, systems, and media for presenting commerce information relating to video content are provided. In accordance with some implementations of the disclosed subject of matter, a method for presenting commerce information relating to video content is provided, the method comprising: receiving a plurality of video frames including a first video frame; detecting, using a hardware processor, a plurality of objects in the plurality of video frames; identifying a plurality of merchandise items corresponding to the detected plurality of objects; obtaining commerce information corresponding to the each of the plurality of merchandise items; associating the commerce information corresponding to each of the plurality of merchandise items with at least one of the plurality of video frames; receiving, from a mobile device, an indication that video content being played back on the mobile device has been paused, wherein the indication includes an identification of the first video frame; and transmitting a response to the mobile device that includes the commerce information associated with the first video frame.

In accordance with some implementations of the disclosed subject of matter, a system for presenting commerce information relating to video content is provided, the system comprising: a hardware processor that is programmed to: receive a plurality of video frames including a first video frame; detect a plurality of objects in the plurality of video frames; identify a plurality of merchandise items corresponding to the detected plurality of objects; obtain commerce information corresponding to the each of the plurality of merchandise items; associate the commerce information corresponding to each of the plurality of merchandise items with at least one of the plurality of video frames; receive, from a user device, an indication that video content being played back on the user device has been paused, wherein the indication includes an identification of the first video frame; and transmit a response to the user device that includes the commerce information associated with the first video frame.

In accordance with some implementations of the disclosed subject of matter, a non-transitory computer-readable medium containing computer-executable instructions that, when executed by a processor, cause the processor to perform a method for presenting commerce information relating to video content, the method comprising: receiving a plurality of video frames including a first video frame; detecting a plurality of objects in the plurality of video frames; identifying a plurality of merchandise items corresponding to the detected plurality of objects; obtaining commerce information corresponding to the each of the plurality of merchandise items; associating the commerce information corresponding to each of the plurality of merchandise items with at least one of the plurality of video frames; receiving, from a user device, an indication that video content being played back on the user device has been paused, wherein the indication includes an identification of the first video frame; and transmitting a response to the user device that includes the commerce information associated with the first video frame.

In accordance with some implementations of the disclosed subject of matter, a system for presenting commerce information relating to video content is provided, the system comprising: means for receiving a plurality of video frames including a first video frame; means for detecting a plurality of objects in the plurality of video frames; means for identifying a plurality of merchandise items corresponding to the detected plurality of objects; means for obtaining commerce information corresponding to the each of the plurality of merchandise items; means for associating the commerce information corresponding to each of the plurality of merchandise items with at least one of the plurality of video frames; means for receiving, from a user device, an indication that video content being played back on the user device has been paused, wherein the indication includes an identification of the first video frame; and means for transmitting a response to the user device that includes the commerce information associated with the first video frame.

In some implementations, the commerce information includes an instruction for purchasing a corresponding merchandise item.

In some implementations, the system further comprises: means for determining whether one of the detected plurality of objects matches one of the plurality of merchandise items contained in a merchandise database.

In some implementations, the system further comprises: means for storing the commerce information that is associated with each of the plurality of the plurality of frames; and means for retrieving the commerce information associated with the first video frame.

In some implementations, the system further comprises: means for ranking the detected plurality of objects based at least in part on the commerce information of the corresponding plurality of merchandise items; and means for associating the commerce information corresponding to each of the plurality of merchandise items with at least one of the plurality of video frames based at least in part on the ranking.

In some implementations, the response includes rendering instructions for displaying the commerce information along with the first video frame.

### BRIEF DESCRIPTION OF THE DRAWINGS

Various objects, features, and advantages of the disclosed subject matter can be more fully appreciated with reference to the following detailed description of the disclosed subject matter when considered in connection with the following drawings, in which like reference numerals identify like elements.

FIG. 1 shows an illustrative example of a process for providing commerce information relating to video content in accordance with some implementations of the disclosed subject matter.

FIG. 2 shows an illustrative example of a process for presenting commerce information relating to video content in accordance with some implementations of the disclosed subject matter.

FIG. 3 shows an illustrative example of a process for obtaining commerce information relating to an object in a video frame in accordance with some implementations of the disclosed subject matter.

FIG. 4 shows an illustrative example of a process for associating commerce information with a video frame in accordance with some implementations of the disclosed subject matter.

FIG. 5A shows an illustrative example of a user interface for presenting video content in accordance with some implementations of the disclosed subject matter.

FIG. 5B shows an illustrative example of a user interface for presenting commerce information relating to video content within the video frame in accordance with some implementations of the disclosed subject matter.

FIG. 5C shows an illustrative example of a user interface for presenting commerce information relating to video content in a commerce window in accordance with some implementations of the disclosed subject matter.

FIG. 5D shows an illustrative screen of a mobile device that presents commerce information relating to video content in accordance with some implementations of the disclosed subject matter.

FIG. 6 is an example of a generalized schematic diagram of a system for presenting commerce information relating to video content in accordance with some implementations of the disclosed subject matter.

FIG. 7 is an example of hardware that can be used in a server, a mobile device, and/or a media playback device of FIG. 6 in accordance with some implementations of the disclosed subject matter.

### DETAILED DESCRIPTION

In accordance with various implementations, as described in more detail below, mechanisms, which can include systems, methods, and computer-readable media, for presenting commerce information relating to video content are provided.

In some implementations, the mechanisms described herein can process video frames of video content (e.g., a television program, streaming video content, etc.) and detect objects in the video frames. For example, the objects can be detected using any suitable object detection technique, such as template matching, video segmentation, edge detection, etc.

In some implementations, upon detecting an object in a video frame of the video content, the mechanisms can search for merchandise items (e.g., products) that match the detected object. For example, the mechanisms can generate an image of the detected object (e.g., an image including a portion of the frame that contains the detected object, a grayscale image, etc.) and generate an image fingerprint from the image (e.g., a normalized pixel value). The mechanisms can then compare the generated image fingerprint against multiple reference image fingerprints that are associated with merchandise items that are stored in a storage device. In some implementations, a reference image fingerprint can be regarded as a matching image fingerprint when a difference (e.g., an absolute difference) between the reference image fingerprint and the generated image fingerprint is less than a predetermined threshold.

In some implementations, upon detecting a matching image fingerprint, the mechanisms can identify a merchandise item associated with the matching image fingerprint and can then associate commerce information relating to the merchandise item with the detected object. In some implementations, the commerce information can include any suitable information relating to the merchandise item, such as identifying information that can be used to identify the merchandise item (e.g., a product name, an index number, a product number, an icon, a barcode, a two-dimensional code, etc.), pricing information about the merchandise item, sellers that can provide the merchandise item, links to websites including information relating to the merchandise item, etc.

It should be noted that, prior to receiving commerce information, these mechanisms can provide the user with an opportunity to provide a consent or authorization to perform actions, such as detecting an object in a video frame, presenting commerce information relating to a merchandise item, submitting payment information for purchasing a merchandise item, and/or placing a merchandise item in a queue. For example, upon loading an application on a media playback device, such as a television device, the application can prompt the user to provide authorization for transmitting commerce information, transmitting payment information, and/or presenting content. In a more particular example, in response to downloading the application and loading the application on the media playback device, the user can be prompted with a message that requires that the user provide consent prior to performing these actions. Additionally or alternatively, in response to installing the application, the user can be prompted with a permission message that requires that the user provide content prior to performing these detections and/or transmitting information relating to these detections. In the instance where the user consents to the use of such data, commerce information relating to one or more merchandise items can be presented and payment information can be transmitted to purchase one or more merchandise items.

In some implementations, in response to receiving a request to pause the presentation of the video content, the mechanisms can retrieve commerce information about the video content. For example, the mechanisms can identify a video frame of the video content that is currently being presented and retrieve commerce information associated with one or more object in the video frame. In some implementations, the mechanisms described herein can present the commerce information associated with the video frame using one or more suitable graphical content items (e.g., images, text snippets, URLs, etc.). For example, a graphical content item that includes commerce information about a merchandise item corresponding to an object in the video frame can be presented along with the object in the video frame.

In some implementations, the mechanisms described herein can prompt a user to interact with one or more of the graphical content items. For example, in response to receiving a user selection of a URL directed to a web page including commerce information associated with a merchandise item presented in the video frame, the mechanisms can cause the web page to be rendered using a suitable application (e.g., a web browser, a mobile application, etc.). As another example, in response to receiving a user selection of a snippet of web content including commerce information of a merchandise item presented in the video frame, the mechanisms can cause additional commercial information relating to the merchandise item (e.g., pricing information, product specification, etc.) to be presented.

In some implementations, the mechanisms can be used in a variety of applications. For example, the mechanisms can provide commerce information relating to merchandise items presented in video content. More particularly, for example, the mechanisms can identify discrete objects in a video frame and match the discrete objects against products and other merchandise items that are available for sale in a product catalogue. The mechanisms can then store commerce information relating to the merchandise items (e.g., prices, product names, sellers of the products, links to ordering information, etc.) in association with video frames of the video content (e.g., by timestamping the commerce information). As another example, the mechanisms can provide commerce information relating to merchandise items presented in video content in a real-time manner. In a more particular example, in response to receiving an indication that a viewer of the video content is interested in merchandise items presented in the video content (e.g., a user request to pause the playback of the video content), the mechanisms can retrieve commerce information relating to the merchandise items and present the commerce information to the viewer. In this example, the mechanisms can provide a viewer that is consuming video content with an opportunity to purchase one or more merchandise items corresponding to identified objects in a video frame and/or an opportunity to place the one or more merchandise items in a queue for making a purchasing decision at a later time without leaving or navigating away from the presented video content.

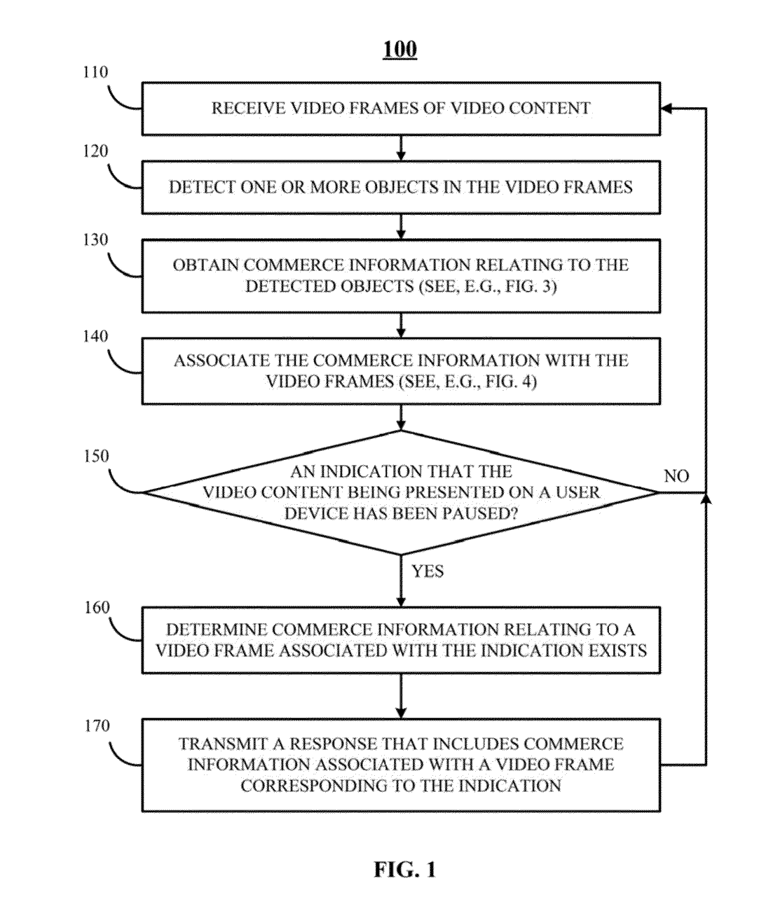

Turning to FIG. 1, a flow chart of an example 100 of a process for providing commerce information relating to video content is shown in accordance with some implementations of the disclosed subject matter.

As illustrated, process 100 can begin by receiving a set of video frames of video content at 110. In some implementations, the video content can include one or more programs (e.g., a news program, a talk show, a sports program, etc.) from various sources, such as programs broadcast over-the-air, programs broadcast by a cable television provider, programs broadcast by a telephone television provider, programs broadcast by a satellite television provider, on-demand programs, over-the-top programs, Internet content, streaming programs, recorded programs, etc.

In some implementations, the video frames can correspond to any suitable portion or portions of the video content, such as a portion of the video content having a particular duration (e.g., a few seconds or any other suitable duration). In some implementations, the video frames can include one or more encoded frames or decoded frames that are generated using any suitable video codec. In some implementations, the video frames can have any suitable frame rate (e.g., 60 frames per second (FPS), etc.), resolution (e.g., 720p, 1080p, etc.), and/or any other suitable characteristic.

Next, at 120, process 100 can process the video frames to detect objects in the video frames. In some implementations, process 100 can process the video frames sequentially, in parallel, and/or in any other suitable manner (e.g., by decoding encoded frames, by generating gray-scale images based on the video frames, by performing object detection and/or recognition on the video frames, etc.)

In some implementations, process 100 can detect one or more objects in the video frames using any suitable object detection technique, such as template matching, image segmentation, edge detection, etc. Additionally, process 100 can recognize one or more of the detected objects using any suitable object recognition technique (e.g., edge matching, greyscale matching, gradient matching, color matching, feature matching, etc.) in some implementations.

In some implementations, one or more capture modules that receive and process signals from multiple sources (e.g., multiple channels, multiple on-demand sources, multiple television providers, etc.). These capture modules can, for each video, capture video screenshots at particular time intervals (e.g., every two or three seconds). Generally speaking, these capture modules can monitor media content from multiple content sources and generate video screenshots and/or any other suitable content identifier. More particularly, these capture modules can store the generated video screenshots and other content identifiers in a storage device. For example, a capture module can monitor channels providing broadcast television content and store generated video fingerprints in a database that is indexed by channel and time. In another example, a capture module can monitor on-demand video sources providing television content and store generated video fingerprints in a database that is indexed by video information and time. These capture modules can, in some implementations, transmit information from the database to an image detection module for detecting one or more objects located within the captured video frames. In response, the capture modules can receive object detection information (e.g., the name of the object, a grayscale image of the object, a fingerprint of the object, etc.). The capture modules can associate the one or more detected objects with the corresponding video information and timing information indexed in the database.

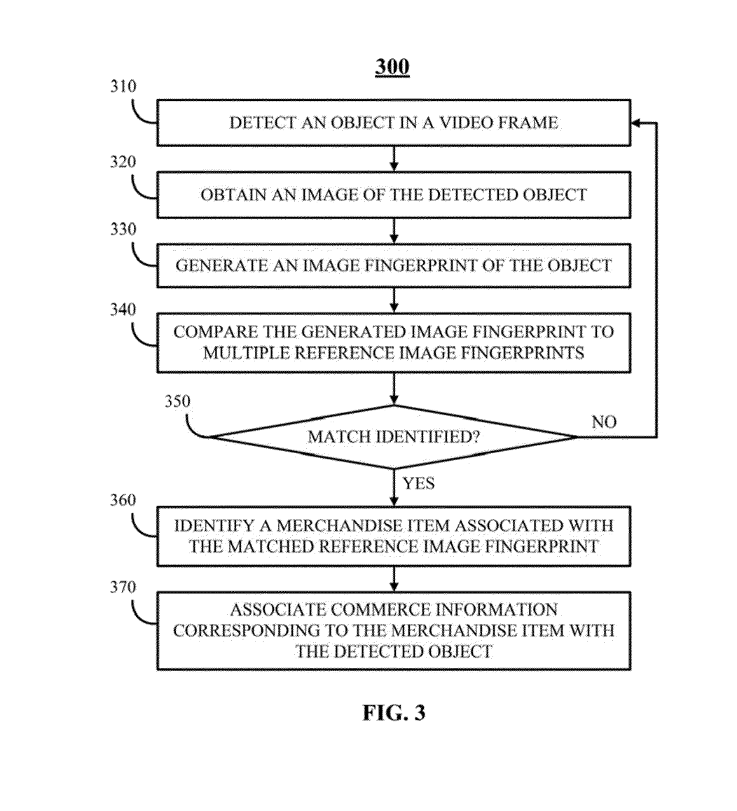

At 130, process 100 can obtain commerce information relating to the detected objects. In some implementations, the commerce information relating to a particular object detected at 120 can be obtained in any suitable manner. For example, process 100 can access a database of merchandise items (e.g., products, services, etc.) and can identify one or more merchandise items that match the object. Process 100 can then associate commerce information relating to the merchandise items with the object. In a more particular example, as described hereinbelow in connection with FIG. 3, a merchandise item that matches an object can be identified by generating a fingerprint from an image of the object and matching the generated fingerprint against reference fingerprints associated with multiple merchandise items.

In some implementations, commerce information relating to an object detected at 120 can include any suitable information relating to one or more merchandise items that match the object. For example, commerce information relating to a particular merchandise item can include an identifier that can identify the merchandise item (e.g., a product identifier), a description of the merchandise item (e.g., a product name), information pertaining to a seller that provides the merchandise item, information pertaining to a manufacture of the merchandise item, customer reviews and/or ratings of the merchandise items, pricing information about the merchandise item, information about a platform on which the merchandise item can be purchased (e.g., an electronic commerce website), etc.

As another example, commerce information relating to a given merchandise item can include any suitable data that can be used to retrieve and/or present information relating to the merchandise item. In a more particular example, the commerce information can include a link (e.g., a uniform resource locator (URL)), a barcode (e.g., a quick response (QR) code), and/or any other suitable mechanism directed to a web page via which the merchandise item(s) can be purchased, a web page including information relating to the merchandise item, and/or any other suitable web content relating to the merchandise item. In another more particular example, the commerce information can include an image, an animation, and/or any other suitable representation of the merchandise item. In yet another more particular example, the commerce information can include a snippet of web content (e.g., a web page, text, video, etc.) including information about the merchandise item.

It should be noted that in implementations described herein in which the media playback application (or other mechanisms described herein) collects information about a particular user, the user can be provided with an opportunity to control whether the application (or other mechanisms) collects information about particular users and/or how collected user information is used by the application (or other mechanisms). Examples of information about a user can include the user's interests (e.g., a paused video frame, a selected merchandise item, etc.), a user's location, names spoken by the user, payment information associated with the user, etc. Additionally, certain information about the user can be stored locally (e.g., not shared), encrypted, and/or treated in one or more ways before it is stored to remove personally identifiable information. For example, a user's identity can be treated such that no personally identifiable information can be determined for the user. As another example, a user's geographic location can be generalized where location information is obtained (e.g., to a city level, a ZIP code level, a state level, etc.), so that a particular location of a user cannot be determined. Using these techniques and others described herein, the user can have control over what information is collected about the user and/or how that information is used by the application (or other mechanisms).

It should also be noted that in implementations described herein in which the media playback application (or other mechanisms described herein) present commerce information to a particular user, the user can be provided with an opportunity to control whether commerce information is presented and/or how commerce information is presented. For example, the user can specify which sources can provide commerce information for presentation to the user. In another example, the user can specify which sources, such as particular electronic commerce retailers, are to be excluded from providing commerce information.

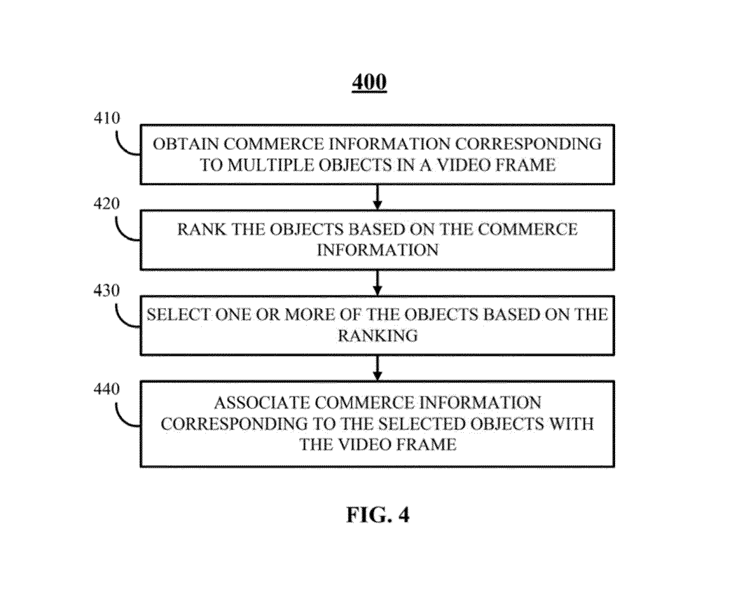

At 140, process 100 can associate the commerce information relating to the detected objects with particular video frames. In some implementations, commerce information relating to one or more objects detected in a particular video frame can be associated with information relating to the particular video frame (e.g., a frame number, timestamp, and/or any other suitable information that can be used to identify the video frame). In some implementations, as described hereinbelow in connection with FIG. 4, one or more objects can be selected from multiple objects that are detected in a video frame. In such an example, commerce information corresponding to the selected objects can be associated with the video frame.

In some implementations, the commerce information can be associated with the video content. For example, the commerce information can be stored in association with any suitable program information relating to the video content, such as a program title, a channel number of a channel that provides the video content, etc. In some implementations, the commerce information corresponding to the video frames can be timestamped to relate to the video content.

In some implementations, process 100 can associate and store the commerce information, program information about the video content (e.g., a channel number, a program title, etc.), information about the video frame (e.g., a frame number, a timestamp, etc.) such that, in response to receiving a subsequent request for commerce information relating to a particular video frame of the video content, the server can retrieve stored commerce information and/or any other suitable information relating to the particular video frame of the video content.

In some implementations, process 100 can monitor channels providing broadcast television content and store commerce information relating to the broadcast television content in a database that is indexed by program and video frame. In a more particular example, process 100 can store commerce information along with timestamped video frames for every N milliseconds in a database while a program is being broadcasted by a television provider or any other suitable content provider.

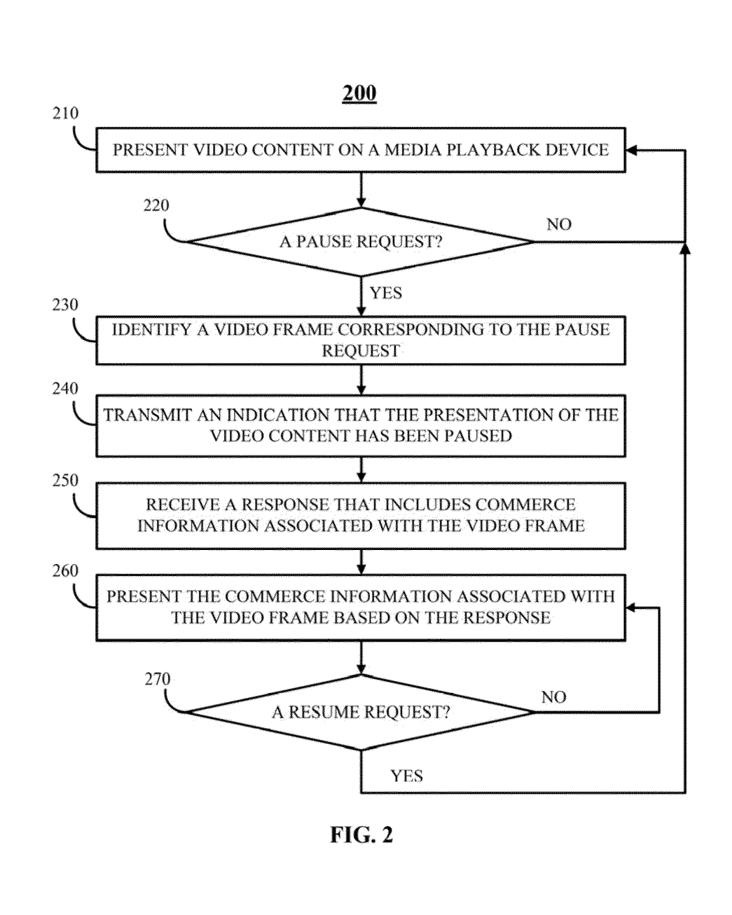

At 150, process 100 can determine whether playback of the video content by a media playback device has been paused. For example, process 100 can receive, from the media playback device, an indication (e.g., an HTTP message) that the video content being played back on the media playback device has been paused. In some implementations, the indication can correspond to a pause request received by the media playback device (e.g., step 220 of FIG. 2).

In some implementations, the indication can be generated by the media playback device (e.g., steps 230-240 of FIG. 2) and can include any suitable information relating to the video content. For example, the indication can include program information relating to the video content, such as a program title, a channel number, etc. As another example, the indication can include information about one or more video frames of the video content, such as frame numbers, timestamps, and/or any other suitable information that can be used to identify the video frames. In a more particular example, the indication can include information relating to a video frame corresponding to a pause request that triggered the transmission of the indication from the media playback device, such as the video frame that was being presented by the media playback device when the pause request was received.

In some implementations, in response to determining that playback of the video content using a media playback device has not been paused (“NO” at 150), process 100 can return to 110.

Alternatively, in response to receiving an indication that the video content being played back on a media playback device has been paused (“YES” at 150), process 100 can identify a video frame associated with the indication and determine whether commerce information has been associated in association with the determined video frame at 160. For example, process 100 can extract, from the indication received at 150, a timestamp or other information relating to the video frame and program information relating to the video content. Process 100 can then determine whether commerce information has been stored in association with the video frame and the video content (e.g., existing commerce information associated with the program information and the timestamp).

In some implementations, in response determining that commerce information has been stored in association with the determined video frame, process 100 can retrieve the stored commerce information and can then transmit a response including the stored commerce information at 170. In some implementations, the response can be transmitted using any suitable communication protocol, such Hypertext Transfer Protocol (HTTP), File Transfer Protocol (FTP), etc.

In some implementations, the response can include any suitable information that can be used to present commerce information associated with the video content. For example, the response can include commerce information associated with the video frame corresponding to the indication. In a more particular example, the response can include a link (e.g., a URL), a QR code, and/or any other suitable mechanism directed to the commerce information associated with the video frame. In another more particular example, the response can include an image, an animation, audio content, a snippet of web content, and/or any other suitable content that can be used to present the commerce information associated with the video frame.

In some implementations, the response can include any suitable information relating to generating and/or rendering graphical content for presenting the commerce information. For example, the response can include positional information about the location and/or size of a region of a screen in which the commerce information can be presented. In a more particular example, such information can include one or more coordinates (e.g., x-coordinates, y-coordinates, and/or z-coordinates) that can define the start positions, end positions, and/or any other suitable parameters of the region in one or more particular dimensions (e.g., x dimension, y dimension, and/or z dimension). In another more particular example, the set of instructions can include one or more coordinates defining the location and/or size of the region with respect to a region in which video content can be displayed, such as the offsets between the two regions, an overlapping region in which both of the video content and the graphical content can be rendered, etc.

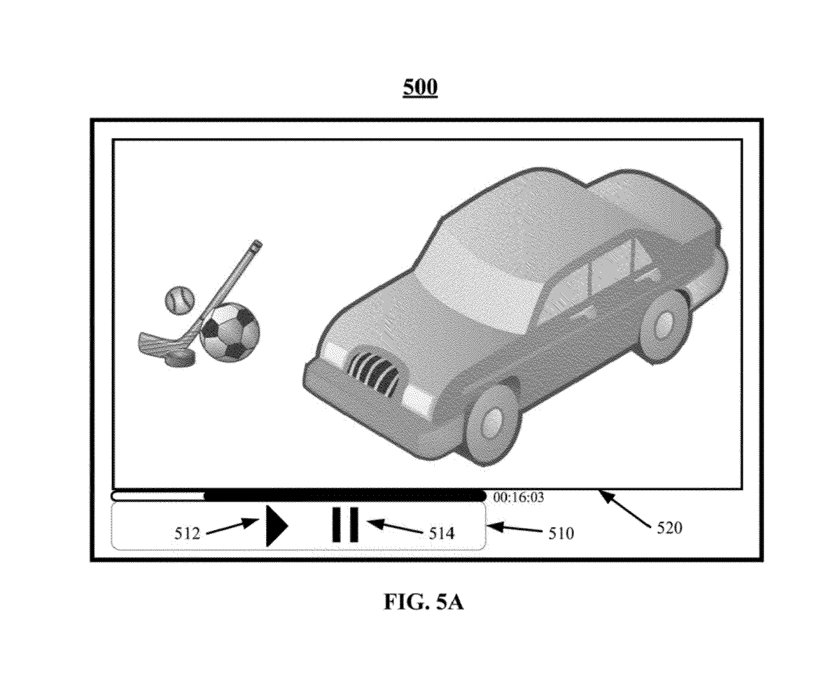

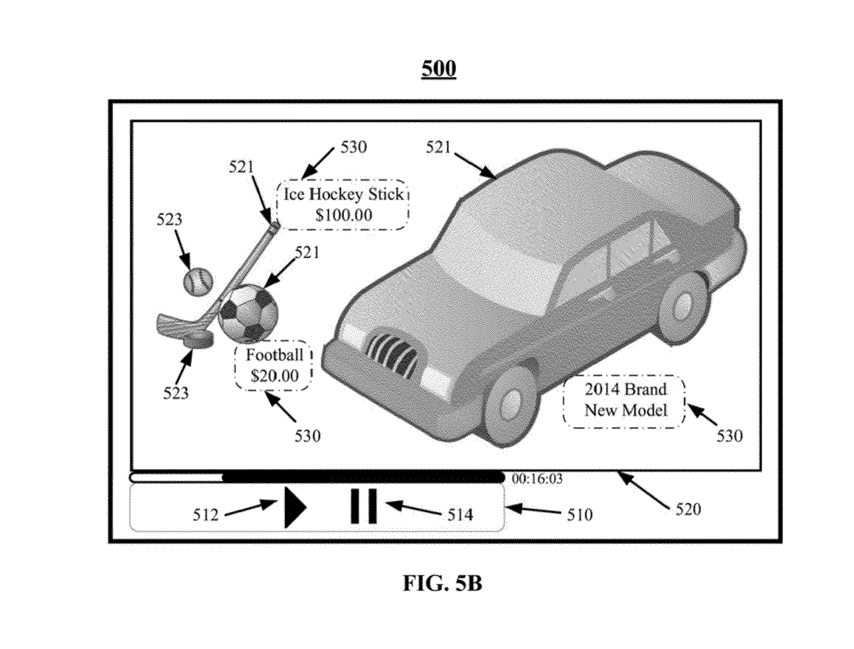

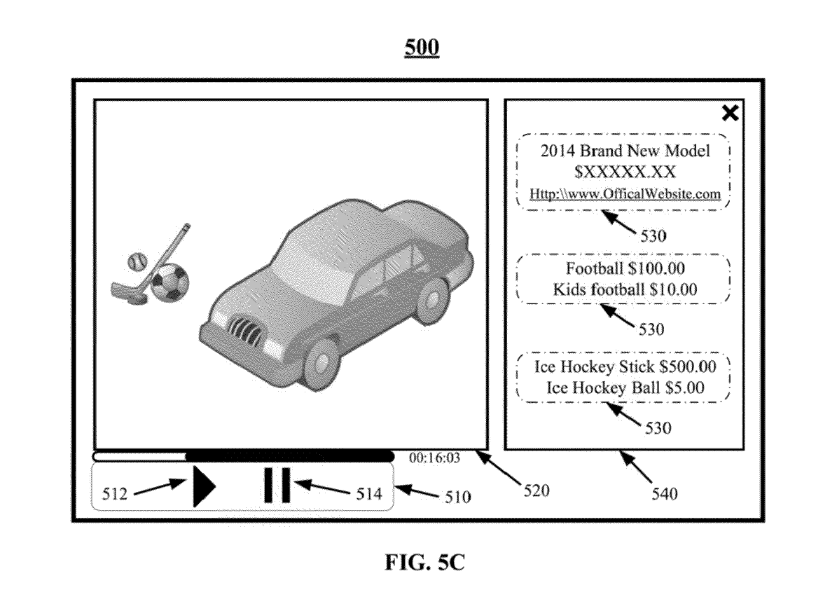

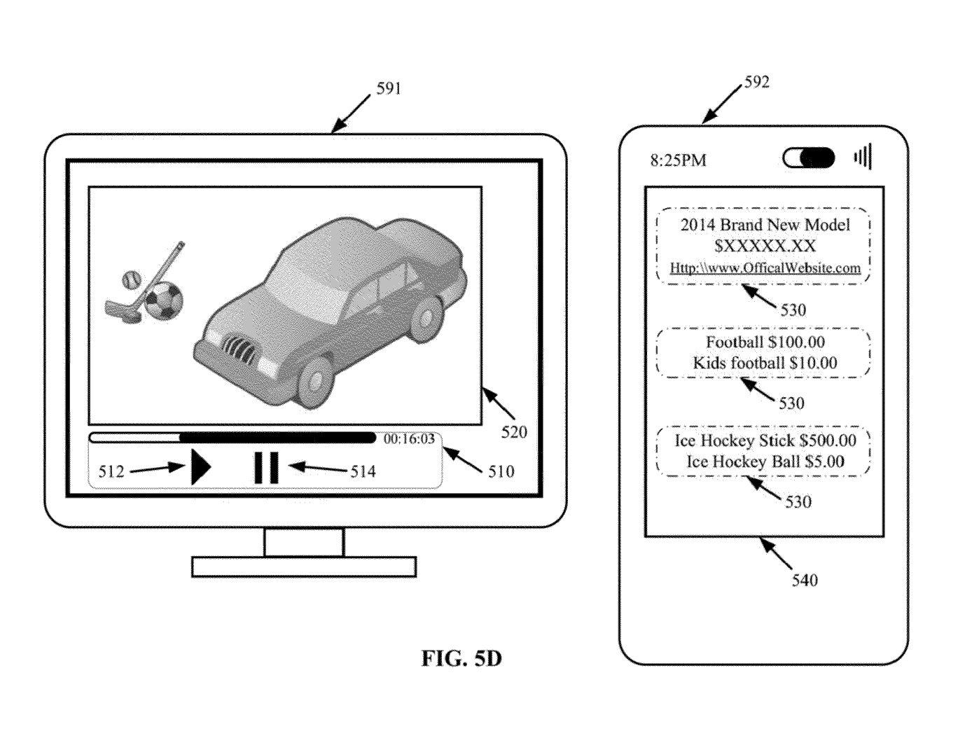

As another example, the response can include one or more rendering instructions that can be used to combine the video content and graphical content items including the commerce information for presentation. In a more particular example, the response can include information relating to colors, a level of transparency, and/or any other suitable parameter that can be used to superimpose a graphical content item including the commerce information (e.g., a graphical content item as shown in FIG. 5B) on a video frame of the video content.

In some implementations, process 100 can return to 110 upon transmitting the response at 170.

Turning to FIG. 2, a flow chart of an example 200 of a process for presenting commerce information relating to video content is shown in accordance with some implementations of the disclosed subject matter.

As illustrated, process 200 can begin by presenting video content using a media playback device. In some implementations, the video content can include one or more programs (e.g., a news program, a talk show, a sports program, etc.) from various sources, such as programs broadcast over-the-air, programs broadcast by a cable television provider, programs broadcast by a telephone television provider, programs broadcast by a satellite television provider, on-demand programs, over-the-top programs, Internet content, streaming programs, recorded programs, etc. In some implementations, the media playback device can be a digital video recorder, a mobile phone, a tablet computer, a laptop computer, a desktop computer, a television, and/or any other suitable device that can present video content.

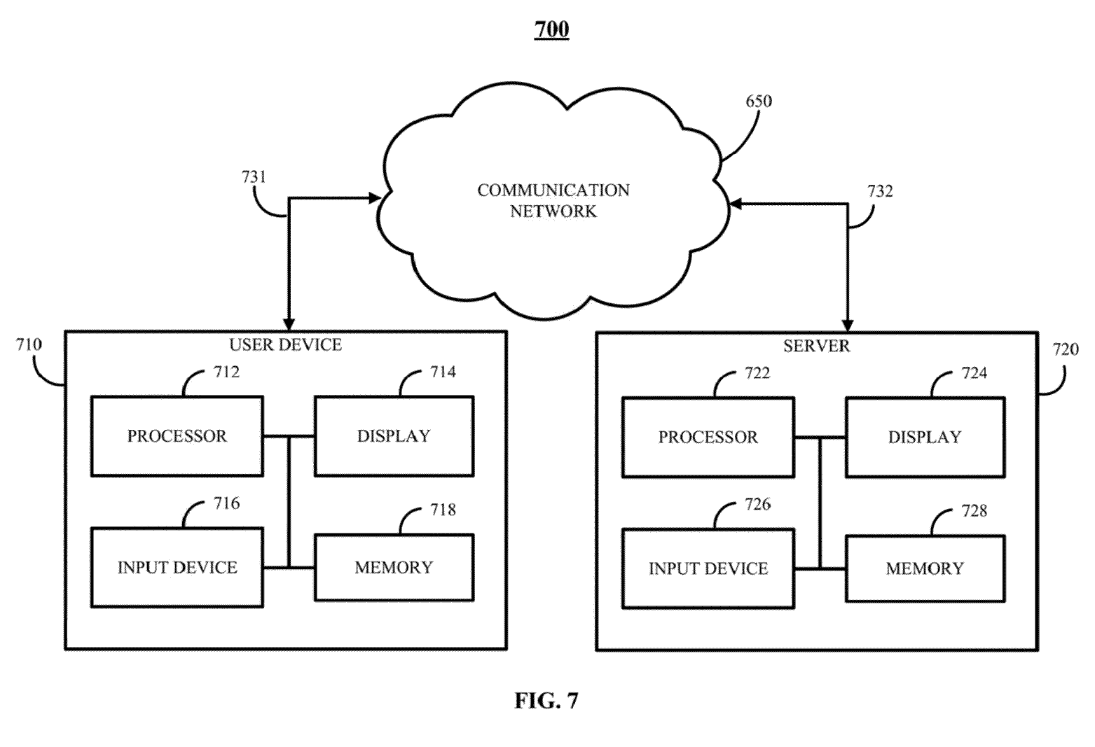

In some implementations, while presenting the video content, process 200 can determine whether a request to pause the presentation of the video content has been received at 220. In some implementations, the pause request can correspond to any suitable user input and can be received using any suitable device. For example, process 200 can determine that a pause request has been received in response to receiving a voice command indicative of a user's desire to pause the presentation of the video content. In a more particular example, a voice command of “pause” can be provided by a user consuming the video content and detected by an audio input device (e.g., a microphone coupled to the media playback device, a mobile device, etc.). As another example, process 200 can determine that a pause request has been received in response to receiving a user selection of a pause button using an input device, such as an input device 716 as illustrated in FIG. 7.

In some implementations, the pause request can be transmitted and received in any suitable form, such as one or more infrared signals, High-Definition Multimedia Interface (HDMI) Consumer Electronics Control (CEC) commands, WiFi signals, and/or any other suitable control signals.

In some implementations, in response to determining that a pause request has not been received (“NO” at 220), process 200 can return to 210 and can continue to present the video content. Alternatively, in response to determining that a pause request has been received (“YES” at 220), process 200 can identify a video frame that corresponds to the pause request at 230. For example, a video frame that was being presented by the media playback device when the pause request was received can be identified as the video frame that corresponds to the pause request. In some implementations, process 200 can associate the identified video frame with a time stamp (e.g., a presentation time stamp), a frame number, and/or any other suitable information that can identify the video frame.

In some implementations, upon receiving the pause request, process 200 can record the video content and/or store the video content in a suitable storage device (e.g., using the media playback device or any other suitable device) for subsequent presentation of the video content.

At 240, process 200 can transmit an indication that the presentation of the video content has been paused. In some implementations, the indication can be transmitted using any suitable communication protocol, such Hypertext Transfer Protocol (HTTP), File Transfer Protocol (FTP), etc.

In some implementations, the indication can include any suitable information relating to the video content. For example, the indication can include program information that can be used to identify the video content. In a more particular example, the program information can include a program title of the video content, a channel number of a channel that provides the video content, and/or any other suitable information that can be used to identify the video content and/or the source of the video content. As another example, the indication can include a frame number, a timestamp, and/or any other suitable information relating to the video frame corresponding to the pause request.

At 250, process 200 can receive a response that includes commerce information associated with the identified video frame. For example, a response generated and transmitted as described above in connection with FIG. 1 can be received in some implementations. In a more particular example, the response can include commerce information relating to one or more objects detected in the identified video frame, such as a URL, images, animations, text snippets, audio content, etc. that can be used to present commerce information relating to one or more merchandise items (e.g., products, services, etc.) corresponding to the objects.

As another more particular example, the response can include information that can be used to present the commerce information associated with the identified video frame, such as one or more rendering instructions relating to generating and/or rendering graphical content items for presenting the commerce information, positional information about the location and/or size of a region of a screen in which the graphical content items can be presented, etc.

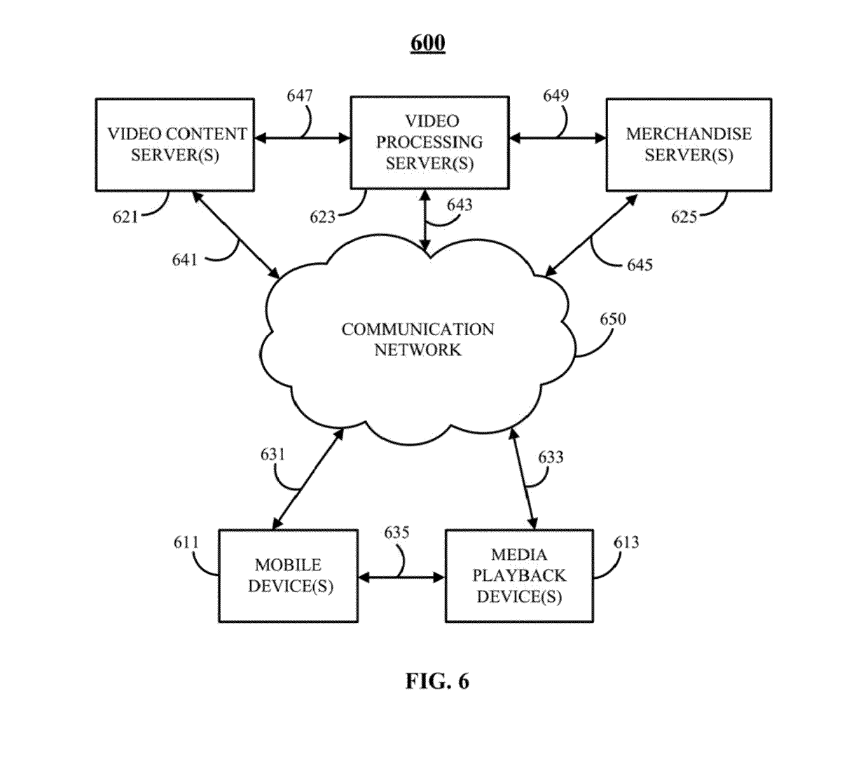

At 260, process 200 can present the commerce information associated with the identified video frame. In some implementations, the commerce information can be presented using any suitable device. For example, as described below in connection with FIGS. 5B and 5C, the commerce information can be presented on a display connected to the media playback device, such as a display 714 as shown in FIG. 7. Alternatively or additionally, as described below in connection with FIG. 5D, the commerce information can be presented on a second screen device, such as a mobile device (e.g., a mobile device 611 as illustrated in FIG. 6).

In some implementations, the commerce information can be presented using any suitable content, such as text, images, icons, graphics, videos, animations, audio clips, hypertext, hyperlinks, sounds, etc.

In some implementations, the commerce information can be presented on a display along with the video frame that corresponds to the pause request. For example, the commerce information can be presented in association with one or more objects in the video frame. In a more particular example, as described below in connection with FIG. 5B, commerce information associated with a given object (e.g., commerce information 530) can be presented in association with the object (e.g., an object 521) in the video frame. In another more particular example, as described below in connection with FIG. 5C, commerce information relating to a given object in the video frame can be presented using a graphical content item (e.g., a URL, an image, an animation, a text snippet, a user interface, etc.) including such commerce information. In some implementations, multiple graphical content items can be generated for multiple objects of the video frame.

In some implementations, one or more of the graphical content items can be generated and/or presented based on the response received at 250. For example, a graphical content item can be generated based on a URL contained in the response. As another example, a graphical content item can be blended with the video frame corresponding to the pause request based on the rendering instructions contained in the received response colors, levels of transparency, and/or any other suitable parameters contained in the response. Additionally, the graphical content item can be superimposed on the video frame based on positional information contained in the response (e.g., coordinates of a region of a screen in which commerce information can be presented).

In some implementations, process 200 can allow a user to interact with one or more of the graphical content items. For example, process 200 can allow a user to scroll through different graphical content items corresponding to the objects by scrolling vertically or horizontally on a mobile device, a media playback device, and/or any other suitable device. In a more particular example, in response to receiving a pause request or any other suitable request from the user, process 200 can present graphical content items within the paused video frame. While scrolling through different graphical content items, process 200 can selectively present commerce information associated with each of the highlighted graphical content items (e.g., price, product specification, seller information, etc.) without leaving the presented video content or without leaving a media application that is playing back the video content. As another example, process 200 can rank the graphical content items based on a user selection of a suitable criterion (e.g., popularity) and can automatically present, on a display, a single content item that corresponds to an object of the video frame. As yet another example, through the graphical content items, process 200 can provide the user with an opportunity to perform one or more purchase actions (e.g., adding an item corresponding to a selected graphical content item to a shopping cart/preferred list, placing an order, making a payment, etc.) with a merchandise item that corresponds to an object of the video frame.

In a more particular example, process 200 can present one or more graphical content items for interaction in response to receiving a pause request or any other suitable indication from the user. As described herein, the one or more graphical content items including commerce information can be displayed in an overlay on the paused video frame, or can be displayed in the interstitial space among the detected objects in the video frame. In response to selecting one of the graphical content items, the corresponding merchandise item can be purchased and a confirmation of the purchased merchandise item can be presented on the display. In some implementations, process 200 can present the user with a purchase confirmation overlay in response to selecting a graphical content item (e.g., “Are you sure you want to buy this?”). Alternatively to purchasing the merchandise item corresponding to the selected graphical content item, the merchandise item can be placed in a queue for purchasing at a later time. As another more particular example, one or more graphical content items for purchasing the merchandise item and/or saving the merchandise item for purchasing at a later time can be provided on a second screen device, such as a mobile device 611 in connection with FIG. 6. For example, in response to selecting multiple merchandise items within one or more paused video frames, the selected merchandise items can be saved in a purchasing queue that is accessible using a mobile device associated with the media playback device presenting the video content.

As described herein, it should be noted that process 200 can provide the user with an opportunity to provide a consent or authorization to perform actions, such as detecting an object in a video frame, presenting commerce information relating to a merchandise item, submitting payment information for purchasing a merchandise item, and/or placing a merchandise item in a queue. For example, upon loading an application on a media playback device, such as a television device, the application can prompt the user to provide authorization for transmitting commerce information, transmitting payment information, and/or presenting content. In a more particular example, in response to downloading the application and loading the application on the media playback device, the user can be prompted with a message that requires that the user provide consent prior to performing these actions. Additionally or alternatively, each time the user selects a merchandise item for purchase or for placement in a queue, the user can be prompted with a permission message that requires that the user provide content to use payment information or any other suitable user information relating to purchasing the merchandise item.

At 270, process 200 can determine whether a request to resume the presentation of the video content has been received. In some implementations, the request can correspond to any suitable user input (e.g., a voice command, a gesture command, a user selection of a play button, etc.), and can be received using any suitable device (e.g., a microphone, a gesture recognition system, a remote control, a mobile phone, etc.).

In some implementations, in response to determining that a request to resume the presentation of the video content has not been received (“NO” at 270), process 200 can return to 260 and can continue to present the commerce information associated with the video frame. Alternatively, process 200 can return to 210 and can resume the presentation of the video content. For example, process 200 can present the video content from the video frame that corresponds to the pause request (e.g., based on video data stored responsive to the pause request).

Turning to FIG. 3, a flow chart of an example 300 of a process for obtaining commerce information relating to an object in a video frame is shown in accordance with some implementations of the disclosed subject matter.

As illustrated, process 300 can begin by detecting an object in a video frame at 310. In some implementations, the object can be detected using any suitable object detection technique or combination of techniques, such as template matching, image segmentation, edge detection, feature-based object detection, etc.

At 320, process 300 can obtain an image of the detected object. For example, process 300 can generate an image including a portion of the video frame that contains the detected object. Additionally or alternatively, process 300 can process the image using any suitable image processing technique to generate a grayscale image, an edge enhanced image, a deblurred image, a bitmap image, etc.

At 330, process 300 can generate a fingerprint of the image of the detected object. In some implementations, the fingerprint can be generated using any suitable image fingerprinting technique. The image fingerprint can be a digital representation generated from the image of the detected object obtained at 320. In some implementations, the image fingerprint of the detected object can include any suitable feature of the image of the detected object. For example, the fingerprint can include optical features of the image, such as luminosity, grayscale, gradient, color, etc. As another example, the fingerprint can include geometric features of the detected object in the image, such as edge templates, viewing direction, size scales, shapes, surface features, etc.

At 340, process 300 can compare the generated image fingerprint to multiple reference image fingerprints in some implementations. For example, the generated image fingerprint can be compared against image fingerprints generated based on image data of a collection of merchandise items (e.g., products, services, etc.). In such an example, process 300 can access a database and/or any other suitable storage device storing image fingerprints indexed by merchandise item to make the comparison.

In some implementations, process 300 can compare the generated image fingerprint to a given reference image fingerprint by measuring the difference between the generated image fingerprint and the reference image fingerprint based on one or more suitable metrics, such as a sum of absolute difference (SAD), a sum of absolute transformed difference (SATD), a sum of squared difference (SSD), etc.

At 350, process 300 can determined whether a match is found. In some implementations, process 300 can identify a reference image fingerprint as being a matching fingerprint in response to determining that the difference between the generated image fingerprint and the reference image fingerprint is less than a predetermined threshold.

If no matching image fingerprint is found (“NO” at 350), process 300 can return to 310 and can performing object detection on the video frame or any other suitable video frame. Alternatively, in response to detecting a matching image fingerprint (“YES” at 350), process 300 can identify a merchandise item associated with the matching image fingerprint at 360.

At 370, process 300 can associate commerce information corresponding to the merchandise item with the detected object. For example, process 300 can retrieve any suitable information relating to the merchandise item and can then store the retrieved information in association with an identifier that identifies the object (e.g., an index number). In some implementations, information relating to the merchandise item can include an identifier that can identify the merchandise item (e.g., a product identifier), a description of the merchandise item (e.g., a product name), information about a seller that provides the merchandise item, information about a manufacture of the merchandise item, customer reviews and/or ratings of the merchandise items, pricing information about the merchandise item, information about a platform on which the merchandise item can be purchased (e.g., an electronic commerce website), etc.

Turning to FIG. 4, a flow chart of an example 400 of a process for associating commerce information with a video frame is shown in accordance with some implementations of the disclosed subject matter.

As illustrated, process 400 can begin by obtaining commerce information corresponding to multiple objects in a video frame at 410. In some implementations, the commerce information can be obtained in any suitable manner. For example, as described above in connection with FIG. 3, commerce information corresponding to a particular object in the video frame can be obtained using process 300.

In some implementations, the commerce information can include any suitable information relating to merchandise items (e.g., products, services, etc.) corresponding to the objects. For example, commerce information relating to a particular merchandise item can include information about a seller that provides the merchandise item, customer reviews and/or ratings of the merchandise item, pricing information about the merchandise item, etc.

At 420, process 400 can rank the objects based on the commerce information associated with the objects. In some implementations, the ranking can be performed based on any suitable criterion or criteria, such as by popularity (e.g., based on customer reviews and/or ratings relating to the merchandise items corresponding to the objects, based on social media information such as trending information and/or hotspots information relating to the merchandise items corresponding to the objects, etc.), by product category (e.g., based on product names and/or classifications associated with the merchandise items), by price (e.g., based on prices of the merchandise items corresponding to the objects), by source (e.g., whether a seller of a merchandise item has subscribed to services provided by process 400), etc.

In some implementations, process 400 can rank the objects based on social media information associated with the objects. For example, one or more capture modules can receive social media information relating to the merchandise items corresponding to the objects from one or more social networks. In a more particular example, process 400 can extract keywords relating to the merchandise items from the received social media information. Process 400 can then determine a social score for each of the extracted keywords relating to the merchandise items based on number of mentions, likes, and/or other social media indicators, and can rank the objects corresponding to the merchandise items based on the determined social score of the extracted keywords.

At 430, process 400 can select one or more detected objects based on the ranking. For example, process 400 can select a predetermined number of objects based on the ranking. In a more particular example, process 400 can select a number of objects associated with particular ranking (e.g., the top 5 objects). In another more particular example, process 400 can select a percentage of the objects based on the determined ranking.

At 440, process 400 can associate commerce information corresponding to the selected objects with the video frame. For example, process 400 can associate and store the commerce information corresponding to the selected objects with the information about the video frame (e.g., a frame number, timestamp, etc.) such that, in response to receiving a subsequent request for commerce information relating to the video frame, the stored commerce information corresponding to the selected objects with the video frame can be retrieved.

It should be noted that the above steps of the flow diagrams of FIGS. 1-4 can be executed or performed in any order or sequence not limited to the order and sequence shown and described in the figure. Also, some of the above steps of the flow diagram of FIGS. 1-4 can be executed or performed substantially simultaneously where appropriate or in parallel to reduce latency and processing times. Furthermore, it should be noted that FIGS. 1-4 are provided as an example only. At least some of the steps shown in the figures may be performed in a different order than represented, performed concurrently, or altogether omitted.

Turning to FIG. 5A, an example of a user interface 500 for presenting video content is shown in accordance with some implementations of the disclosed subject matter. In some implementations, user interface 500 can include control panel 510, video content display area 520, and/or any other suitable user interface elements.

In some implementations, control panel 510 can include multiple user interface elements for performing control functions associated with video playback, such as skip backward or forward buttons (not shown), play button 512, pause button 514, stop button (not shown), mute button (not shown), volume control bar (not shown), and any other suitable video control interface elements. In some implementations, control panel 510 may contain more or fewer video control interface elements that are illustrated in FIG. 5A, or may be omitted (e.g., in a case of voice control).

In some implementations, content display area 520 can be used to present any suitable video content. In some implementations, if a pause request (e.g., clicking pause button 514) is received, a video frame corresponding to the pause request (e.g., a video frame identified at 230) can be presented in video content display area 520.

FIGS. 5B, 5C, and 5D show illustrative examples of user interfaces for presenting commerce information relating to video content in accordance with some implementations. For example, one or more commerce information presentation items 530 can be used to present commerce information relating to one or more detected object 521 or 523 within the video frame corresponding to the pause request.

Although not shown in FIG. 5B, 5C, or 5D, in some implementations, one or more detected objects 521 and 523 within the video frame corresponding to the pause request can be indicated in the video content display area 520. In some implementations, one or more objects 521 and 523 that have been detected at 120 in connection with FIG. 1 can be indicated in content display area 520 in any suitable manner. For example, one or more objects 521 and 523 can be indicated by one or more user interface elements, such as one or more pointers, one or more light spots, one or more color spots, enhanced frame(s) of one or more objects, etc. As another example, when a mouse pointer is moved by a user to the position of a detected object, a sound, a light, a popup window, and/or any other suitable user interface elements can be used to indicate the detected object.

In some implementations, a commerce information presentation item 530 can present any suitable commerce information relating to a detected object 521 or 523, such as a snippet of commerce information (e.g., a quick fact or any other suitable text snippet), a thumbnail image, a link (e.g., a uniform resource locator (URL)) or a barcode (e.g., a quick response (QR) code) directed to a web page for additional content, an extracted keyword mentioned in subtitle information, etc.

In some implementations, a commerce information presentation item 530 can be presented in any suitable manner. For example as illustrated in FIG. 5B, commerce information presentation item 530 can be provided within a floating window that overlay the video content presentation area 520. In a more particular example, a commerce information presentation item 530 can be provided as a transparency, where the commerce information can be overlaid on the video content presentation area 520. In another example, as illustrated in FIG. 5C, one or more commerce information presentation items 530 can be provided and listed in a commerce information window 540 positioned adjacent to the video content presentation area 520. In yet another example, as illustrated in FIG. 5D, the video frame corresponding to the pause request can be presented on a first screen device 591 (e.g., a media playback device 613 in connection with FIG. 6), while one or more commerce information presentation items 530 can be provided and listed in a commerce information window 540 that can be presented on a second screen device 592 (e.g., a mobile device 611 in connection with FIG. 6).

In some implementations, one or more commerce information presentation items 530 can be associated with one or more objects 521. In some implementations, one or more commerce information presentation items associated with one or more objects 523 can be hidden or omitted. In some implementations, a commerce information presentation item 530 associated with an object 523 can be presented in response to receiving a user request, such as a selection of the object 523. It should be noted that, although there are three commerce information presentation items 530 shown in FIGS. 5B, 5C, and 5D respectively, any suitable number of commerce information presentation items (including none) can be presented to a user.

Although not shown in FIG. 5B, 5C, or 5D, in some implementations, commerce information presentation items 530 can be interacted with by a user. For example, commerce information presentation items 530 can be removed from user interface 500 if a user is not interested or is no longer interested in the commerce information presented on the commerce information presentation items. In a particular example, in some implementations, a commerce information presentation item 530 can be dismissed by clicking or tapping on the commerce information presentation item 530 or on a “dismiss” icon (e.g., an “X” at the corner of the commerce information presentation item 530 or any other suitable icon). As another particular example, in some implementations, a commerce information presentation item 530 can be dismissed by swiping or dragging the commerce information presentation item off the border of user interface 500. Similarly, commerce information presentation items 530 can be selected by clicking, tapping, or any other suitable mechanism, in some implementations.

As another example, a commerce information presentation item 530 can be selected to perform an action or present additional information (e.g., access a link to review an introduction or specification relating to a merchandise item that corresponds to the detected object). In a more particular example, if a commerce information presentation item 530 which presents a link to a merchandise website, the commerce information presentation item 530 can be selected, and in response, an action can be performed, for example, launching a web browsing application that accesses a page with information and/or purchase selections of the corresponding merchandise item. As another more particular example, if a commerce information presentation item 530 which presents a video that introduces the corresponding merchandise item, the commerce information presentation item 530 can be selected, and in response, the video can be displayed to the user. In another suitable example, a commerce information presentation item 530 can include one or more user interface elements to allow a user to make a purchase of the corresponding merchandise item (e.g., placing an order and/or making a payment). In a further suitable example, selecting a commerce information presentation item 530 can cause the corresponding merchandise item to be placed in a queue for making a purchasing decision at a later time.

Turning to FIG. 6, an example 600 of a generalized schematic diagram of a system for presenting commerce information relating to video content is shown in accordance with some implementations of the disclosed subject matter. As illustrated, system 600 can include one or more video content servers 621, one or more video processing servers 623, one or more merchandise servers 625, a communication network 650, one or more mobile devices 611, one or more media playback devices 613, communication links 631, 633, 635, 641, 643, 645, 647 and 649, and/or other suitable components.

Video content server(s) 621 can include one or more servers that can stream or serve video content and/or perform any other suitable functions. For example, video content server(s) 621 can include a telephone television provider, a satellite television provider, a video streaming service, a video hosting service, etc.

Video processing server(s) 623 can include one or more servers that are capable of receiving, processing, storing, and/or delivering video content, performing object detection and/or recognition, receiving, processing, storing, and/or providing commerce information relating to merchandise items, searching for matching merchandise items, and/or performing any other suitable functions.

Merchandise server(s) 625 can include one or more servers that are capable of storing commerce information of merchandise items, image fingerprints associated with merchandise items, and/or any other suitable information, searching for matching merchandise items, and/or performing any other suitable function.

Mobile device(s) 611 can be or include any suitable device that is capable of receiving, processing, converting, transmitting, and/or rendering media content, receiving user requests, and/or performing any other suitable functions. For example, mobile device(s) 611 can be implemented as a mobile phone, a tablet computer, a wearable computer, a television device, a set-top box, a digital media receiver, a game console, a personal computer, a laptop computer, a personal data assistant (PDA), a home entertainment system, any other suitable computing device, or any suitable combination thereof.

Media playback device(s) 613 can be or include any suitable device that is capable of performing other suitable functions relating to media content, such as presenting video content, presenting commerce information relating to video content, etc. For example mobile device can be implemented as a mobile phone, a tablet computer, a wearable computer, a television device, a personal computer, a laptop computer, a home entertainment system, a vehicle (e.g., a car, a boat, an airplane, etc.) entertainment system, a portable media player, or any suitable combination thereof.

In some implementations, each of video content server(s) 621, video processing server(s) 623, merchandise server(s) 625, mobile device(s) 611, and media playback device(s) 613 can be any of a general purpose device, such as a computer or a special purpose device such as a client, a server, etc. Any of these general or special purpose devices can include any suitable components such as a hardware processor (which can be a microprocessor, digital signal processor, a controller, etc.), memory, communication interfaces, display controllers, input devices, a storage device (which can include a hard drive, a digital video recorder, a solid state storage device, a removable storage device, or any other suitable storage device), etc.

In some implementations, communications network 650 can be any suitable computer network or combination of such networks including the Internet, an intranet, a wide-area network (WAN), a local-area network (LAN), a wireless network, a digital subscriber line (DSL) network, a frame relay network, an asynchronous transfer mode (ATM) network, a virtual private network (VPN), etc.

In some implementations, video processing server(s) 623 can be connected to video content server(s) 621 and merchandise server(s) 625 through communications links 647 and 649, respectively. Mobile device(s) 611 can be connected to media playback device(s) 613 through communication links 635. Mobile device(s) 611, media playback device(s) 613, video content server(s) 621, video processing server(s) 623, and merchandise server(s) 625 can be connected to communications network 650 through communications links 631, 633, 641, 643, and 645, respectively. Communications links 631, 633, 635, 641, 643, 645, 647, and 649 can be and/or include any communications links suitable for communicating data among mobile device(s) 611, media playback device(s) 613, video content server(s) 621, video processing server(s) 623, and merchandise server(s) 625, such as network links, dial-up links, wireless links, hard-wired links, any other suitable communications links, or any suitable combination of such links.

In some implementations, each of video content server(s) 621, video processing server(s) 623, and merchandise server(s) 625, mobile device(s) 611, and media playback device(s) 613 can be implemented as a stand-alone device or integrated with other components of system 600. For example, one or more content servers 621, one or more video processing servers 623, and one or more merchandise servers 625 can be implemented as one service system in some implementations. As another example, one or more mobile devices 611 and one or more media playback devices 613 can be implemented as one user system in some implementations.

FIG. 7 illustrates an example 700 of hardware that can be used to implement a user device (e.g., a mobile device 611 and/or a media playback device 613 in connection with FIG. 6), and a server 720 (e.g., a video content server 621, a video processing server 623, and/or a merchandise server 625 in connection with FIG. 6) in accordance with some implementations of the disclosed subject matter. Referring to FIG. 7, user device 710 can include a hardware processor 712, a display 714, an input device 716, and memory 718, which can be interconnected. In some implementations, memory 718 can include a storage device (such as a non-transitive computer-readable medium) for storing a computer program for controlling hardware processor 712.

Hardware processor 712 can use the computer program to present on display 714 content and/or an interface that allows a user to interact with the web browsing application and to send and receive data through communications link 731. It should also be noted that data received through communications link 731 or any other communications links can be received from any suitable source. In some implementations, hardware processor 712 can send and receive data through communications link 731 or any other communication links using, for example, a transmitter, receiver, transmitter/receiver, transceiver, or any other suitable communication device. Input device 716 can be a computer keyboard, a mouse, a trackball, a keypad, a remote control, any other suitable input device, or any suitable combination thereof. Additionally or alternatively, input device 716 can include a touch screen display 714 that can receive input (e.g. using a finger, a stylus, or the like).

Server 720 can include a hardware processor 722, a display 724, an input device 726, and memory 728, which can be interconnected. In some implementations, memory 728 can include a storage device for storing data received through communications link 732 or through other links, and processor 722 can receive commands and values transmitted by one or more users of, for example, user device 710. The storage device can further include a server program for controlling hardware processor 722.

The mechanisms described herein for presenting commerce information relating to video content can be implemented in user devices 710 and/or servers 720 as software, firmware, hardware, or any suitable combination thereof.

In some implementations, server 720 can be implemented as one server or can be distributed as any suitable number of servers. For example, multiple servers 720 can be implemented in various locations to increase reliability, function of the application, and/or the speed at which the server can communicate with user devices 710.

In some implementations, the application can include client-side software, server-side software, hardware, firmware, or any suitable combination thereof. For example, the application can encompass a computer program that causes one or more processors to execute the content generation application. As another example, the application(s) can encompass a computer program written in a programming language recognizable by mobile device 611 and/or server 621 that is executing the application(s) (e.g., a program written in a programming language, such as, Java, C, Objective-C, C++, C#, Javascript, Visual Basic, HTML, XML, ColdFusion, any other suitable approaches, or any suitable combination thereof).

In some implementations, the application can encompass one or more Web-pages or Web-page portions (e.g., via any suitable encoding, such as HyperText Markup Language (“HTML”), Dynamic HyperText Markup Language (“DHTML”), Extensible Markup Language (“XML”), JavaServer Pages (“JSP”), Active Server Pages (“ASP”), Cold Fusion, or any other suitable approaches).

In some implementations, any suitable computer readable media can be used for storing instructions for performing the processes described herein. For example, in some implementations, computer readable media can be transitory or non-transitory. For example, non-transitory computer readable media can include media such as magnetic media (such as hard disks, floppy disks, and/or any other suitable media), optical media (such as compact discs, digital video discs, Blu-ray discs, and/or any other suitable optical media), semiconductor media (such as flash memory, electrically programmable read only memory (EPROM), electrically erasable programmable read only memory (EEPROM), and/or any other suitable semiconductor media), any suitable media that is not fleeting or devoid of any semblance of permanence during transmission, and/or any suitable tangible media. As another example, transitory computer readable media can include signals on networks, in wires, conductors, optical fibers, circuits, any suitable media that is fleeting and devoid of any semblance of permanence during transmission, and/or any suitable intangible media.

The provision of the examples described herein (as well as clauses phrased as “such as,” “e.g.,” “including,” and the like) should not be interpreted as limiting the claimed subject matter to the specific examples; rather, the examples are intended to illustrate only some of many possible aspects.

Accordingly, methods, systems, and media for presenting commerce information relating to video content are provided.

Although the disclosed subject matter has been described and illustrated in the foregoing illustrative implementations, it is understood that the present disclosure has been made only by way of example, and that numerous changes in the details of implementations of the disclosed subject matter can be made without departing from the spirit and scope of the disclosed subject matter, which is limited only by the claims that follow. Features of the disclosed implementations can be combined and rearranged in various ways.

What is claimed is:

1. A method for presenting commerce information relating to video content, the method comprising:
receiving a plurality of video frames including a first video frame;
detecting, using a hardware processor, a plurality of objects in the plurality of video frames;
identifying a plurality of merchandise items corresponding to the detected plurality of objects;
obtaining commerce information corresponding to the each of the plurality of merchandise items;
associating the commerce information corresponding to each of the plurality of merchandise items with at least one of the plurality of video frames;
receiving, from a mobile device, an indication that video content being played back on the mobile device has been paused, wherein the indication includes an identification of the first video frame; and
transmitting a response to the mobile device that includes the commerce information associated with the first video frame.

2. The method of claim 1, wherein the commerce information includes an instruction for purchasing a corresponding merchandise item.

3. The method of claim 1, further comprising determining whether one of the detected plurality of objects matches one of the plurality of merchandise items contained in a merchandise server.

4. The method of claim 1, further comprising:
storing the commerce information that is associated with each of the plurality of the plurality of frames; and
retrieving the commerce information associated with the first video frame.

5. The method of claim 1, further comprising:
ranking the detected plurality of objects based at least in part on the commerce information of the corresponding plurality of merchandise items; and
associating the commerce information corresponding to each of the plurality of merchandise items with at least one of the plurality of video frames based at least in part on the ranking.

6. The method of claim 1 wherein the response includes rendering instructions for displaying the commerce information along with the first video frame.

7. A system for presenting commerce information relating to video content, the system comprising:
a hardware processor that is programmed to:
receive a plurality of video frames including a first video frame;
detect a plurality of objects in the plurality of video frames;
identify a plurality of merchandise items corresponding to the detected plurality of objects;
obtain commerce information corresponding to the each of the plurality of merchandise items;
associate the commerce information corresponding to each of the plurality of merchandise items with at least one of the plurality of video frames;
receive, from a user device, an indication that video content being played back on the user device has been paused, wherein the indication includes an identification of the first video frame; and
transmit a response to the user device that includes the commerce information associated with the first video frame.

8. The system of claim 7, wherein the commerce information includes an instruction for purchasing a corresponding merchandise item.

9. The system of claim 7, wherein the hardware processor is further programmed to determine whether one of the detected plurality of objects matches one of the plurality of merchandise items contained in a merchandise database.

10. The system of claim 7, wherein the hardware processor is further programmed to:
store the commerce information that is associated with each of the plurality of the plurality of frames; and
retrieve the commerce information associated with the first video frame.

11. The system of claim 7, wherein the hardware processor is further programmed to:
rank the detected plurality of objects based at least in part on the commerce information of the corresponding plurality of merchandise items; and
associate the commerce information corresponding to each of the plurality of merchandise items with at least one of the plurality of video frames based at least in part on the ranking.

12. The system of claim 7, wherein the response includes rendering instructions for displaying the commerce information along with the first video frame.

13. A non-transitory computer-readable medium containing computer-executable instructions that, when executed by a processor, cause the processor to perform a method for presenting commerce information relating to video content, the method comprising:
receiving a plurality of video frames including a first video frame;
detecting, using a hardware processor, a plurality of objects in the plurality of video frames;
identifying a plurality of merchandise items corresponding to the detected plurality of objects;
obtaining commerce information corresponding to the each of the plurality of merchandise items;
associating the commerce information corresponding to each of the plurality of merchandise items with at least one of the plurality of video frames;
receiving, from a user device, an indication that video content being played back on the user device has been paused, wherein the indication includes an identification of the first video frame; and
transmitting a response to the user device that includes the commerce information associated with the first video frame.

14. The non-transitory computer-readable medium of claim 13, wherein the commerce information includes an instruction for purchasing a corresponding merchandise item.

15. The non-transitory computer-readable medium of claim 13, wherein the method further comprises determining whether one of the detected plurality of objects matches one of the plurality of merchandise items contained in a merchandise database.

16. The non-transitory computer-readable medium of claim 13, wherein the method further comprises:
storing the commerce information that is associated with each of the plurality of the plurality of frames; and
retrieving the commerce information associated with the first video frame.

17. The non-transitory computer-readable medium of claim 13, wherein the method further comprises:
ranking the detected plurality of objects based at least in part on the commerce information of the corresponding plurality of merchandise items; and
associating the commerce information corresponding to each of the plurality of merchandise items with at least one of the plurality of video frames based at least in part on the ranking.

18. The non-transitory computer-readable medium of claim 13, wherein the response includes rendering instructions for displaying the commerce information along with the first video frame.
